(19) United States
(12) Patent Application Publication
(10) Pub. No.: US 2026/0320161 A1
(43) Pub. Date: Oct. 15, 2026

(54) Authenticated Multi-Account Recommendation System

(71) Applicant: Yordanka Diaz leyva, San Julians (MT)

(72) Inventor: Yordanka Diaz leyva, San Julians (MT)

(21) Appl. No.: 19/634,302

(22) Filed: Mar. 31, 2026

(51) Int. Cl. G06F 21/10; G06F 16/735

(52) U.S. Cl. CPC G06F 21/1015; G06F 16/735

(57) ABSTRACT

A computer-implemented recommendation system operates within an embedded streaming-provider interface. A user selects a decision-assistance control presented by a provider environment, and the system determines whether a provider account is already authenticated. If needed, a provider login flow is invoked. Provider catalogue data and account activity data are used to generate recommendations for a solo mode, a shared viewing mode, or a family-viewing mode. In the shared viewing mode, a together-mode selection and a viewer-count input are received, first and second provider accounts are authenticated in sequence, provider-side taste profile data for both accounts is retrieved, and recommendations are generated automatically from the combined data without a questionnaire. In the solo mode, a reduced-friction input including genre or vibe and time available may refine the recommendations. The system further captures interaction and engagement events for presentation in a provider-facing dashboard or transmission to external retention or analytics systems.

### CROSS-REFERENCE TO RELATED APPLICATIONS

[Reserved.]

### STATEMENT REGARDING FEDERALLY SPONSORED RESEARCH OR DEVELOPMENT

No federally sponsored research or development is claimed.

### FIELD OF THE INVENTION

The present disclosure relates generally to computer-implemented recommendation systems and, more particularly, to embedded streaming-provider interfaces that authenticate one or more user accounts, generate content recommendations from account activity and catalogue constraints, and provide provider-side analytics and integration signals.

### BACKGROUND

Streaming providers commonly maintain extensive catalogues, user-account information, watch histories, and playback telemetry. Even with existing personalization systems, viewers often experience decision friction before playback, especially when a viewer does not know what to watch, when two viewers attempt to watch together, or when household viewing includes children. Conventional recommendation interfaces frequently require extended browsing, manual searching, or repeated filtering, which can increase abandonment before playback and reduce engagement.

Existing systems also tend to optimize for a single profile and may not efficiently create a shared recommendation set when multiple authenticated viewers want to watch together. In family-viewing situations, conventional systems may not adequately balance household constraints, such as age appropriateness, runtime, and adult-viewer suitability. Moreover, providers may lack a dedicated embedded interaction that captures indecision events and converts those events into measurable engagement and retention signals.

### SUMMARY

In one aspect, a computer-implemented system is provided for generating recommendations within an embedded streaming-provider interface. The system may include a provider interface element configured to launch a drawer, modal, or widget in response to a user selection of a decision-assistance control; an authentication layer configured to determine whether a user is already authenticated with the provider and, when not authenticated, to invoke provider login; a recommendation engine configured to receive provider catalogue data and user-account activity data and to generate one or more recommended content items; and an output layer configured to present the recommended content items and route a user to a title page or playback surface.

In another aspect, the system supports a shared-viewing mode in which a viewing-together selection is received, a viewer count is received, a first account is authenticated, a second account is authenticated, account activity data associated with both accounts is retrieved from the provider environment, and a shared recommendation set is automatically generated without requiring a questionnaire after authentication of the two accounts.

In another aspect, the system supports a solo mode in which a single authenticated user launches the embedded interface and provides a reduced-friction preference input comprising at least a genre or vibe selection and a time-available selection, whereupon the system combines the user account history with the immediate preference input to generate recommendations.

In another aspect, the system supports a with-kids mode in which one or more authenticated adult accounts invoke a family-viewing context and the recommendation engine applies age-appropriateness and household suitability constraints.

In another aspect, the system generates event outputs associated with indecision interactions, recommendation generation, recommendation clicks, playback starts, session completions, invitation acceptance, and viewing-mode usage, and exposes such outputs through a provider-facing dashboard and an integration gateway for transmission to external retention, customer-engagement, analytics, or orchestration systems.

### BRIEF DESCRIPTION OF THE DRAWINGS

FIG. 1 is a block diagram of an example system architecture for generating recommendations in an embedded provider environment.

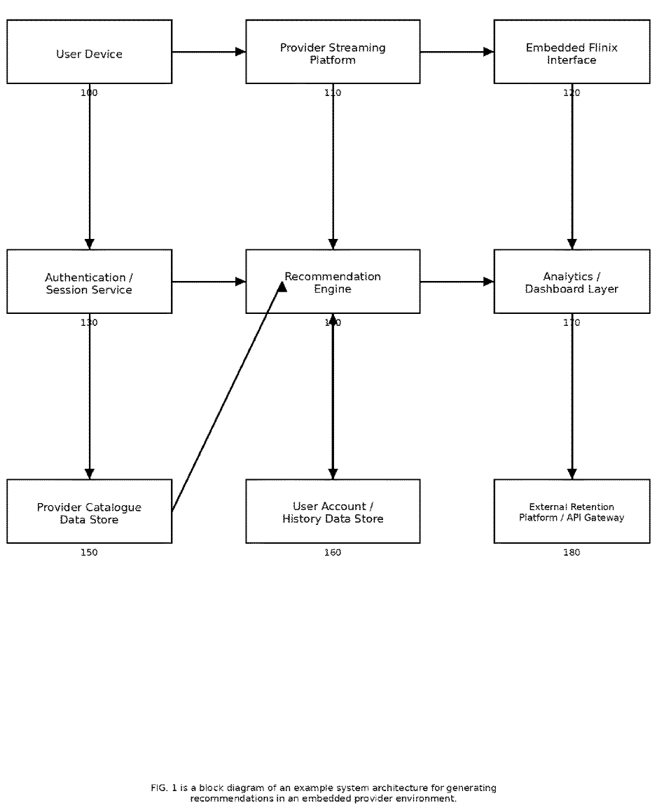

FIG. 2 is a schematic interface view showing an embedded content-selection entry point and an opened decision drawer within a provider interface.

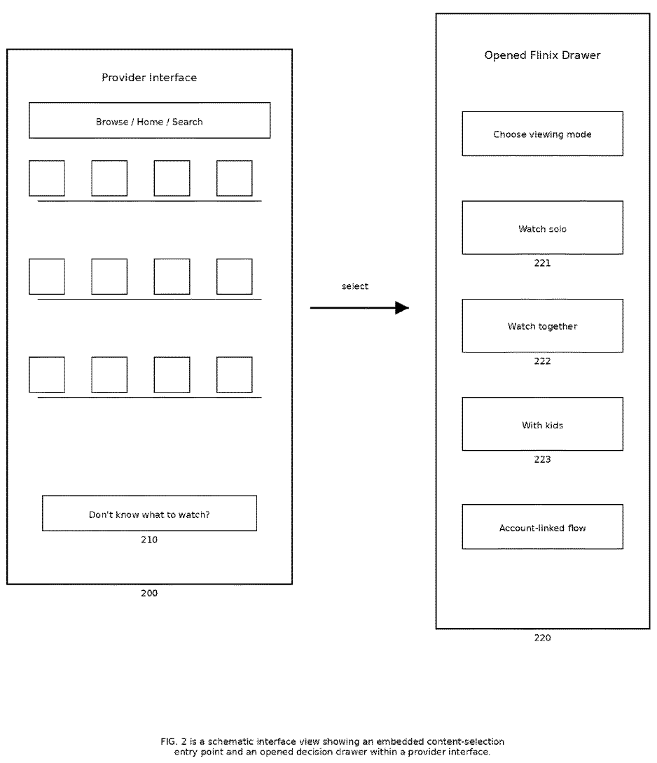

FIG. 3 is a flow diagram of an example single-user recommendation process.

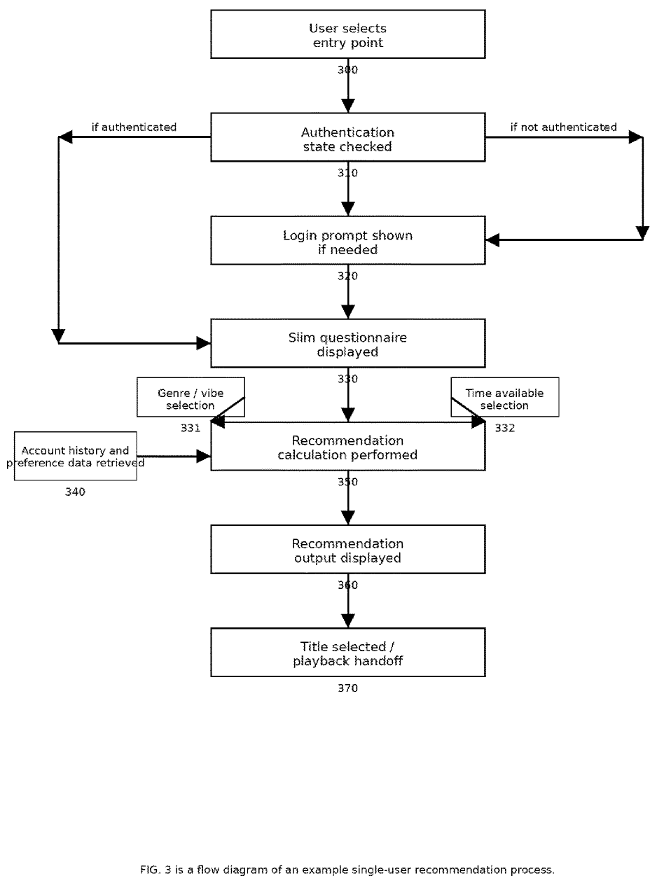

FIG. 4 is a flow diagram of an example shared recommendation process in which a together mode is selected, a viewer count is received, first and second accounts are authenticated, provider-side taste profiles are fetched, and matches are generated automatically.

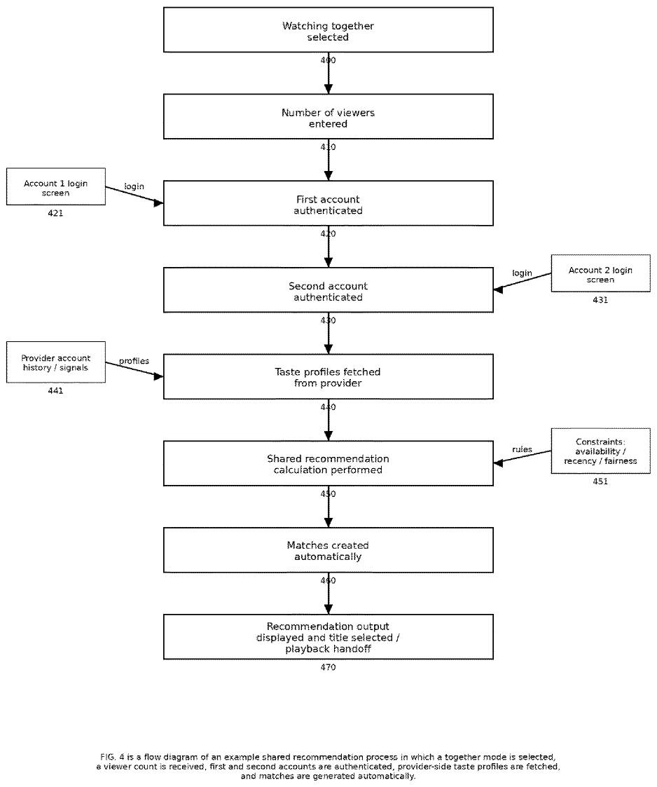

FIG. 5 is a block diagram of an example shared recommendation engine using combined account profiles, shared constraints, filtering, scoring, and ranked output generation.

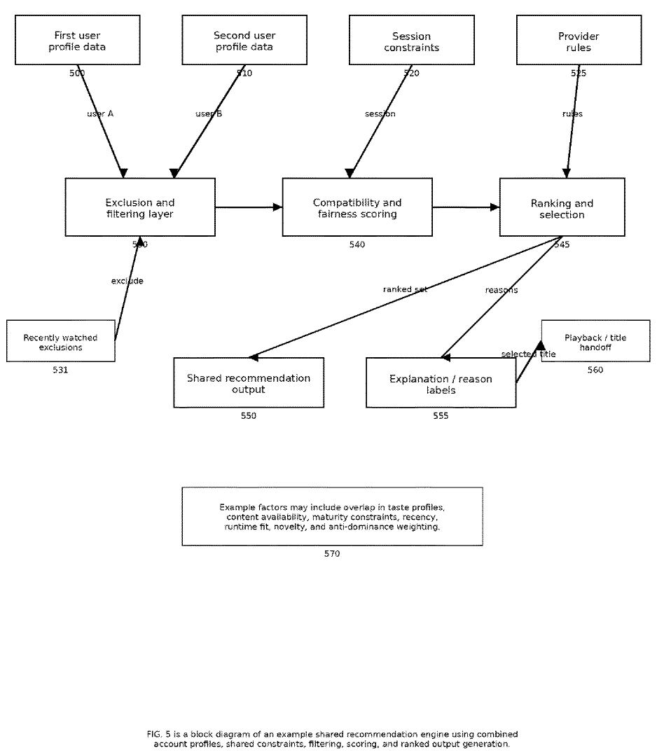

FIG. 6 is a block diagram of an example family-viewing recommendation process using family-mode inputs, provider maturity data, filtering, suitability evaluation, and ranking.

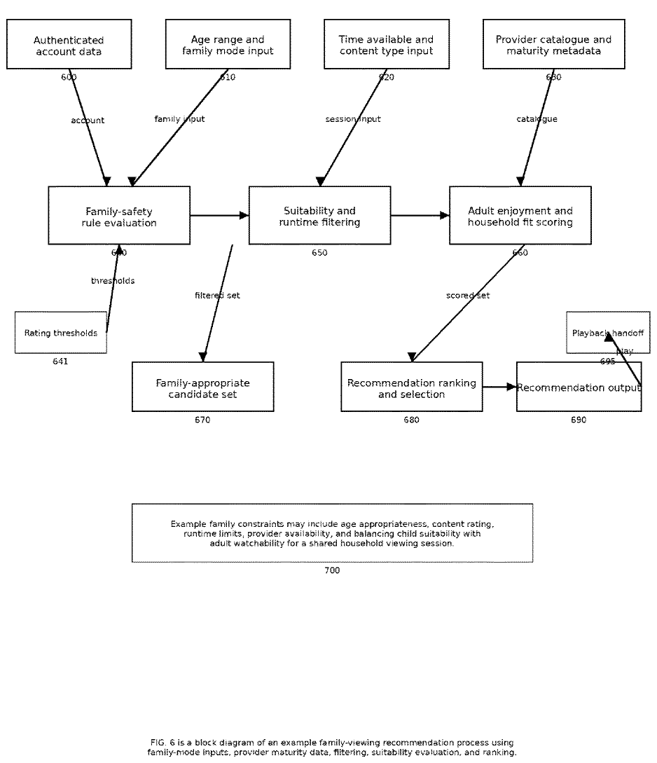

FIG. 7 is a block diagram of an analytics and gateway architecture for collecting interaction events, generating provider metrics, and exporting signals to external retention systems.

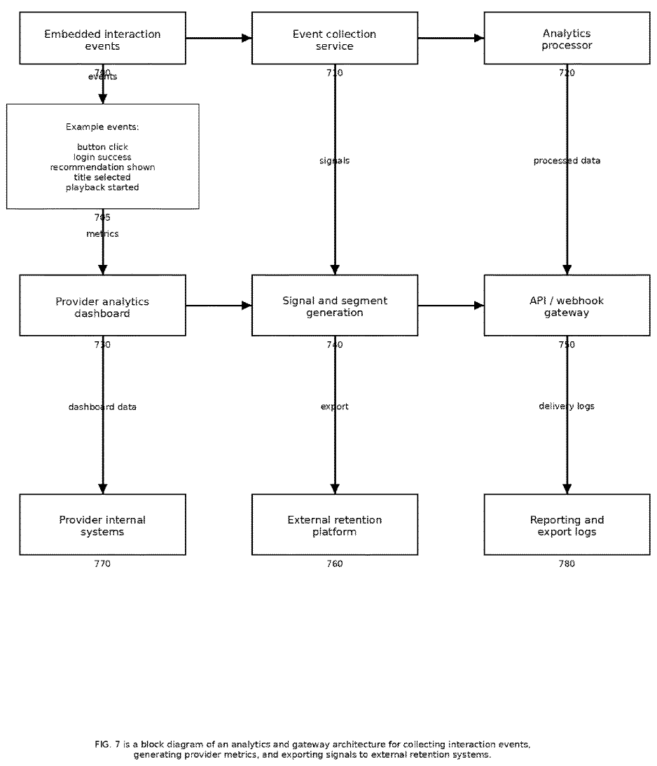

### DETAILED DESCRIPTION OF THE INVENTION

### Overview

Referring generally to the disclosed embodiments, the disclosed system may be implemented as an embedded decision layer integrated into a streaming provider environment. The provider environment may include account-management systems, authentication systems, catalogue management systems, entitlement systems, title-detail pages, playback surfaces, and provider-side data pipelines. The embedded decision layer may be invoked through a user-facing control such as “Don't know what to watch?”, “Can't decide?”, “Watch together”, or “Watching with kids?”.

The decision layer may be configured as a drawer, modal, side panel, inline widget, JavaScript component, web component, software development kit, application programming interface, or a combination thereof. In preferred implementations, the decision layer uses provider account authentication and provider catalogue data as primary sources of truth rather than relying on unauthenticated consumer input.

### System Components

An example system may include: (a) a provider interface element; (b) an authentication manager; (c) a session manager; (d) a catalogue ingestion and normalization layer; (e) a recommendation engine; (f) a shared-profile combination module; (g) a family-viewing filter module; (h) an analytics event pipeline; (i) a provider dashboard service; and (j) an external integration gateway.

The provider interface element may be embedded on one or more provider pages and may call a decision-layer service in response to a user action. The authentication manager may determine whether a first-party provider session already exists and may request provider-approved login if needed. The session manager may create and maintain solo, shared, or household recommendation sessions. The catalogue ingestion and normalization layer may receive title identifiers, title metadata, ratings, runtime values, maturity indicators, territorial availability, editorial priorities, and playback-routing information.

The recommendation engine may operate on provider-controlled content items and may receive historical activity signals, immediate session signals, and rule-based constraints. The shared-profile combination module may compute compatibility values across at least two authenticated accounts. The family-viewing filter module may apply age constraints, maturity constraints, runtime thresholds, and household suitability weighting. The analytics event pipeline may capture interaction and downstream engagement events. The provider dashboard service may aggregate the events for reporting. The external integration gateway may transmit events and derived attributes to third-party or internal retention systems.

### Authentication and Session Initialization

Upon user selection of the interface element, the system may query the provider environment for an existing authenticated state. If a valid session token or authenticated state is present, the system may proceed without requiring additional credentials. If an authenticated state is absent or invalid, the system may invoke a provider-controlled login prompt, single sign-on flow, or token handoff.

In a solo session, the session manager may create a recommendation session for a single authenticated account. In a shared session, the session manager may first receive a together-mode selection and a viewer-count input. For a two-viewer session, the system may authenticate a first account and then prompt for authentication of a second account through provider-controlled login or provider-recognized account credentials such as an email address or phone number. After the second account is authenticated, the session manager may associate both authenticated accounts with the shared session and may proceed to automatic shared recommendation generation.

### Solo Recommendation Flow

In a solo mode, the system may present a reduced-friction prompt set rather than an extended questionnaire. In one example, the prompt set includes a genre or vibe selection and a time-available selection. The recommendation engine may then combine the immediate prompt values with historical account activity, including recent watch history, completion patterns, content-type preferences, runtime tendencies, and recency exclusions.

The recommendation engine may rank candidate titles from the provider catalogue according to a composite score that reflects historical affinity, present-session constraints, catalogue availability, and optional business rules. Recommended titles may be returned automatically within the same interface without requiring additional search terms. The interface may present one or more recommended titles with associated artwork, runtime, reason codes, and action controls that redirect to a title page, watchlist flow, or playback flow.

### Shared Recommendation Flow

In a watch-together mode, the system may receive a together-mode selection and a viewer-count value indicating how many viewers are participating. In a first implementation, the value corresponds to two viewers. The system may authenticate a first account, then prompt for authentication of a second account using a provider-recognized account credential flow such as an email or phone-number-based login interface. After the second account is authenticated, the shared-profile combination module may retrieve activity vectors or taste profiles for both accounts from the provider environment.

In some embodiments, the system avoids simply averaging the two profiles. Instead, the system may apply fairness weighting, compatibility scoring, recency exclusions, novelty constraints, runtime fit, and anti-dominance controls so that the output set reflects both users' histories while avoiding repeated favoritism toward one user's profile. The recommendation engine may then automatically generate a shared recommendation set without presenting a questionnaire after the first and second accounts are authenticated.

### With-Kids Recommendation Flow

In a with-kids mode, the system may receive a family-viewing indication from the interface and may optionally receive an age-band input, a time-available input, or a content-type input. The family-viewing filter module may apply content ratings, maturity values, age-appropriateness rules, runtime thresholds, and household suitability scores. The recommendation engine may produce candidate titles that satisfy the child-viewing constraints while also considering adult account signals to avoid recommending content that is suitable for children but unlikely to be accepted by adult viewers.

In some embodiments, a single authenticated adult account may be sufficient to initiate the with-kids mode. In other embodiments, two adult accounts may be combined before applying the family-viewing filter module.

### Analytics and Dashboard Functions

The analytics event pipeline may capture decision-layer events, including button impressions, interface opens, login prompts, login success, recommendation generation, recommendation clicks, playback starts, session completions, invitation transmissions, invitation acceptance, viewing-mode selections, and recommendation abandonment. The dashboard service may aggregate such events to generate provider-facing analytics views.

Example dashboard metrics may include usage counts, recommendation funnel conversion, click-through rate, playback-start rate, recommendation-to-playback latency, usage by mode, top-performing titles, title-level conversion, and friction-point analysis. The dashboard may be used initially for analytics overview and may later support direct actions or automated rules.

### Integration Gateway

The external integration gateway may expose an application programming interface, webhook framework, event-export service, message queue, or other connector mechanism that allows the provider to send decision-layer events or derived signals to external or internal systems. Example destinations may include retention systems, customer relationship management systems, personalization engines, data warehouses, and campaign orchestration tools.

The gateway may transmit raw events, normalized events, derived segments, household-viewing indicators, decision-friction indicators, or recommendation-performance signals. In some embodiments, the gateway enables the provider to keep an existing retention system while receiving new decision-layer signals from the disclosed embedded interface.

### Data Processing and Privacy Controls

In some embodiments, the system stores only a limited subset of provider account data required to generate recommendations or analytics. The provider may remain the source of truth for account identity, entitlement, playback rights, and catalogue access. Token-based authentication, expiring session references, pseudonymous identifiers, or abstracted taste vectors may be used to reduce unnecessary storage of raw personal data.

The system may operate in a multi-tenant environment where tenant-specific branding, data mapping, maturity rules, dashboard visibility, event destinations, and recommendation constraints are isolated per provider.

### Implementation Notes

The methods described herein may be implemented by one or more processors executing instructions stored in non-transitory computer-readable media. The system may be deployed as cloud-hosted services, provider-hosted services, or hybrid architectures. Certain functions may be performed in real time, near real time, or batch-supported modes depending on partner architecture and latency constraints.

The foregoing description is intended to illustrate rather than limit the scope of the invention. Variations, substitutions, and combinations of the disclosed features may be made without departing from the scope of the appended claims.

What is claimed is:

1. A computer-implemented system for generating content recommendations within an embedded streaming-provider interface, the system comprising:
one or more processors; and
one or more non-transitory computer-readable media storing instructions that, when executed by the one or more processors, cause the system to:
receive an invocation of an embedded decision interface from a provider-controlled user interface;
determine an authentication state associated with a first user account of a streaming provider;
when the authentication state is not valid, invoke a provider authentication flow;
receive provider catalogue data and account activity data associated with the first user account; and
generate and present, in the embedded decision interface, one or more recommended content items selected from the provider catalogue data based at least in part on the account activity data.

2. The system of claim 1, wherein the embedded decision interface is launched from a button, drawer, modal, side panel, or widget labeled to indicate that the user does not know what to watch.

3. The system of claim 1, wherein the instructions further cause the system to bypass additional credential collection when the first user account is already authenticated in the provider-controlled user interface.

4. The system of claim 1, wherein the instructions further cause the system to receive, for a solo recommendation mode, a reduced-friction preference input comprising at least a genre or vibe selection and a time-available selection, and to generate the one or more recommended content items further based on the reduced-friction preference input.

5. The system of claim 1, wherein the instructions further cause the system to:
receive a selection of a shared viewing mode;
receive a viewer-count input;
authenticate the first user account;
receive a provider-recognized credential for a second user account;
authenticate the second user account;
retrieve provider-side taste profile data associated with the first user account and the second user account; and
generate a shared recommendation set based on the provider-side taste profile data associated with both the first user account and the second user account.

6. The system of claim 5, wherein the shared recommendation set is generated without presenting a questionnaire after the first user account and the second user account are authenticated.

7. The system of claim 5, wherein generating the shared recommendation set comprises applying fairness weighting, runtime fit, recency exclusions, and anti-dominance logic such that recommendations are not determined solely by a highest-affinity profile among the first user account and the second user account.

8. The system of claim 1, wherein the instructions further cause the system to receive a family-viewing mode selection and, in response, apply age-appropriateness constraints, maturity constraints, and household suitability weighting before presenting the one or more recommended content items.

9. The system of claim 1, wherein the instructions further cause the system to capture interaction events associated with the embedded decision interface and expose at least a portion of the interaction events through a provider-facing dashboard or an external integration gateway.

10. A computer-implemented method for generating content recommendations within an embedded streaming-provider interface, the method comprising:
receiving, by one or more processors, a user selection of an embedded decision interface presented within a streaming-provider environment;
determining whether a first user account is already authenticated with the streaming-provider environment;
when the first user account is not authenticated, invoking a provider login flow;
retrieving provider catalogue data and account activity data associated with the first user account;
computing one or more recommendation scores for content items represented in the provider catalogue data; and
outputting one or more recommended content items through the embedded decision interface.

11. The method of claim 10, further comprising receiving a solo-mode input indicating a preferred genre or vibe and a time-available value before computing the one or more recommendation scores.

12. The method of claim 10, further comprising:
receiving a selection of a shared viewing mode;
receiving a viewer-count input;
authenticating the first user account;
receiving a provider-recognized credential for a second user account;
authenticating the second user account;
retrieving provider-side taste profile data associated with the first user account and the second user account;
combining the provider-side taste profile data; and
computing a shared recommendation set based on the combined provider-side taste profile data.

13. The method of claim 12, wherein combining the provider-side taste profile data comprises excluding content items already consumed by at least one of the first user account and the second user account according to one or more provider-configurable rules.

14. The method of claim 10, further comprising generating and transmitting, through an application programming interface or webhook interface, one or more events that characterize decision-interface usage, recommendation generation, recommendation clicks, playback starts, authentication success, or shared-viewing initiation.

15. The method of claim 10, further comprising receiving a with-kids mode selection and generating the one or more recommended content items by applying age-band filtering and adult-viewer suitability weighting.

16. A non-transitory computer-readable medium storing instructions that, when executed by one or more processors, cause the one or more processors to:
present an embedded decision interface within a streaming-provider user interface;
determine an existing authentication state for a provider account;
retrieve provider catalogue data and account activity data for the provider account;
generate one or more content recommendations for a solo mode, a shared mode, or a family-viewing mode; and
transmit at least one event generated by use of the embedded decision interface to a provider analytics system or a provider-designated retention system.

17. The non-transitory computer-readable medium of claim 16, wherein the shared mode comprises receiving a viewer-count input, authenticating a first provider account and a second provider account in sequence, retrieving provider-side taste profiles for the first provider account and the second provider account, and automatically generating recommendations after the second provider account is authenticated.

18. The non-transitory computer-readable medium of claim 16, wherein the family-viewing mode comprises applying maturity constraints and runtime constraints while preserving provider catalogue eligibility and playback availability.
